(19) United States
(12) Patent Application Publication
(10) Pub. No.: US 2019/0334895 A1
(43) Pub. Date: Oct. 31, 2019

(54) FORWARDING A REQUEST TO A RADIUS SERVER

(71) Applicant: Hewlett Packard Enterprise Development LP, Houston, TX (US)

(72) Inventors: Suganya J S A, Bangalore (IN); Paradi Nagaraj, Bangalore (IN); Mohanraju Thangamani, Bangalore (IN)

(21) Appl. No.: 15/965,458

(22) Filed: Apr. 27, 2018

(51) Int. Cl. H04L 29/06; H04W 12/06; H04L 29/08

(52) U.S. Cl. CPC H04L 63/0876; H04L 67/1004; H04W 12/06; H04L 63/102

(57) ABSTRACT

An example network device is disclosed comprising a memory and a processor to execute instructions stored in the memory to receive a notification that a load level of a first Remote Authentication Dial-In User Service (RADIUS) server of a plurality of RADIUS servers for network access authentication of a network has exceeded a first threshold load level, receive a request from a client device to access a network resource in the network and forward the request to a second RADIUS server from the plurality of RADIUS servers, wherein the second RADIUS server is different from the first RADIUS server.

### BACKGROUND

When a user wishes to access a network or a network resource, a request may be sent to a Remote Authentication Dial-In User Service (RADIUS) server to authorize or authenticate the user before access is granted. Requests may be distributed among multiple client RADIUS servers for load balancing.

### BRIEF DESCRIPTION OF DRAWINGS

Examples will now be described, by way of non-limiting example, with reference to the accompanying drawings, in which:

FIG. 1 is a simplified schematic of an example of a network device:

FIG. 2 is a simplified schematic of an example of a network device;

FIG. 3 is a flow chart of an example of a method, for example a method of distributing a network access request between RADIUS servers;

FIG. 4 is a flow chart of an example of a method, for example a method of distributing a network access request between RADIUS servers;

FIG. 5 is a simplified schematic of an example of a machine-readable medium; and

FIG. 6 is a simplified schematic of an example of a machine-readable medium.

### DETAILED DESCRIPTION

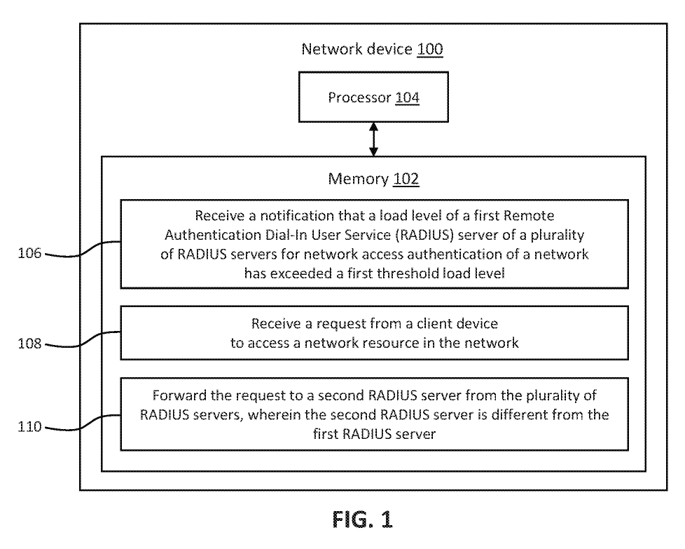

FIG. 1 is a simplified schematic of an example of a network device 100. In some examples, the network device 100 may be or implement a RADIUS server or a RADIUS Dynamic Authorization Server (DAC) (which may in some examples be a capability of a RADIUS server). As used herein, a “network device” generally includes a device that is adapted to transmit and/or receive signaling and to process information within such signaling and to provide wireless local area network services to a station (e.g., any data processing equipment such as a computer, cellular phone, personal digital assistant, tablet devices, etc.). The “network device” may include access points, data transfer devices, network switches, routers, controllers, etc. As used herein, an “access point” (AP) generally refers to receiving points for any known or convenient wireless access technology which may later become known. Specifically, the term AP is not intended to be limited to IEEE 802.11-based APs. APs generally function as an electronic device that is adapted to allow wireless devices to connect to a wired network via various communications standards.

The network device 100 comprises a memory 102 and a processor 104. The processor 104 is to execute instructions 106 stored in the memory 102 to receive a notification that a load level of a first Remote Authentication Dial-In User Service (RADIUS) server of a plurality of RADIUS servers for network access authentication of a network has exceeded a first threshold load level. In some examples, the request may be generated and/or sent by the first RADIUS server.

The first RADIUS server may thus for example inform the network device 100 when its load level exceeds the first threshold. The notification may in some examples be sent by the first RADIUS server in response to the load level exceeding the threshold, or may in some examples be sent as periodic notifications that indicate whether or not the load level is above the threshold.

The processor 104 is also to execute instructions 108 stored in the memory 102 to receive a request from a client device to access a network resource in the network. The request from the client device may in some examples be authentication or authorization details, for example received from a captive portal to which the client device is directed when it attempts to access the network or a resource in the network.

The processor 104 is also to execute instructions 110 stored in the memory 102 to forward the request to a second RADIUS server from the plurality of RADIUS servers, wherein the second RADIUS server is different from the first RADIUS server. Therefore, the request is not forwarded to the first RADIUS server as it has indicated that its load level is above the threshold. This may for example avoid overloading the first RADIUS server. The second RADIUS server may in some examples then process the request and allow or deny access for the client device accordingly. In some examples, one or more of the plurality of RADIUS servers is a RADIUS Dynamic Authorization Client (DAC).

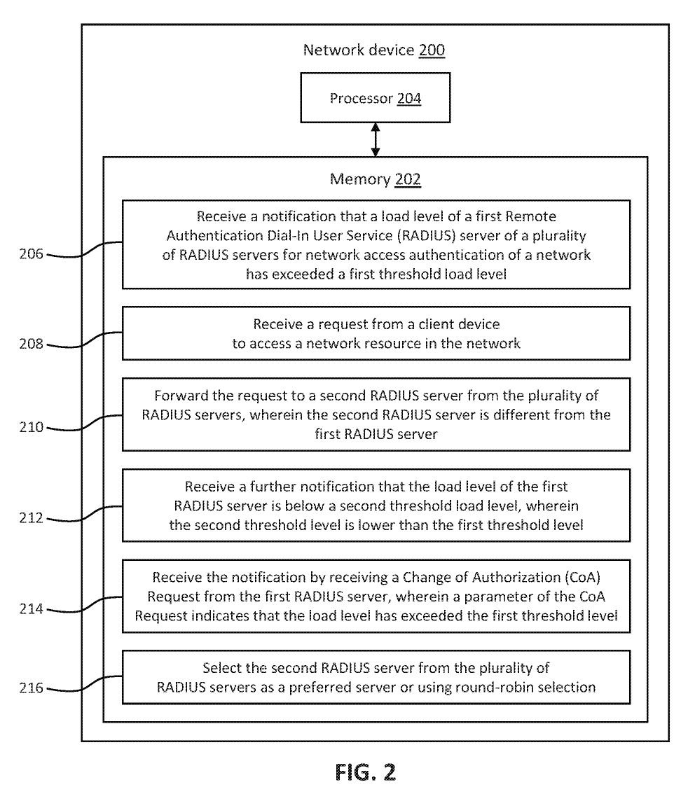

FIG. 2 is a simplified schematic of an example of a network device 200. In some examples, the network device 200 may be or implement a RADIUS server or a RADIUS Dynamic Authorization Server (DAC). The network device 200 comprises a memory 202 and a processor 204. The processor 204 is to execute instructions 206 stored in the memory 202 to receive a notification that a load level of a first Remote Authentication Dial-In User Service (RADIUS) server of a plurality of RADIUS servers for network access authentication of a network has exceeded a first threshold load level.

The processor 204 is also to execute instructions 208 stored in the memory 202 to receive a request from a client device to access a network resource in the network, and instructions 210 stored in the memory 202 to forward the request to a second RADIUS server from the plurality of RADIUS servers, wherein the second RADIUS server is different from the first RADIUS server. In some examples, the instructions 206, 208 and 210 may be similar or identical to the instructions 106, 108 and 110 respectively described above with reference to FIG. 1.

In some examples, the load level may be represented by a value that rises above a threshold value when the load level exceeds a threshold level. In other examples, the load level may be represented by a value that falls below a threshold value when the load level exceeds a threshold level, and in such examples a lower value may indicate a higher load level.

The processor 204 is also to execute instructions 212 stored in the memory 202 to receive a further notification that the load level of the first RADIUS server is below a second threshold load level, wherein the second threshold level is lower than the first threshold level. Therefore, for example, the first RADIUS server may inform the network device 200 that its load level has fallen and that the first RADIUS server may begin accepting requests again. As a result, for example, subsequent requests received at the network device 200 may be distributed between the first and second RADIUS servers in any suitable manner (e.g. round-robin, or a preferred one of the first and second RADIUS servers). The second threshold level is below the first threshold level to, for example, reduce the likelihood that multiple notifications are received in a short period of time if the load level of the first RADIUS server is close to the first threshold level.

The processor 204 is also to execute instructions 214 stored in the memory 202 to receive the notification by receiving a Change of Authorization (CoA) Request (CoA-request) from the first RADIUS server, wherein a parameter of the CoA Request indicates that the load level has exceeded the first threshold level. For example, the CoA-request may indicate a vendor type with a value of 130 (RADIUS_VENDOR_ATTR_ARUBA_SERVER_LOAD), a vendor length of 1, and an attribute specific value of 1 which indicates that the load level of the first RADIUS server has exceeded the first threshold, and that for example the first RADIUS server would prefer not to receive further requests.

The processor 204 is also to execute instructions 216 stored in the memory 202 to select the second RADIUS server from the plurality of RADIUS servers as a preferred server or using round-robin selection. Another of the plurality of RADIUS servers may also in some examples be selected for processing a request in a similar manner, excluding the first RADIUS server if a notification has been received that the load level of the first RADIUS server has exceeded the first threshold, and including the first RADIUS server if a notification has been received that the load level of the first RADIUS server is below the second threshold.

In some examples, the network device 200 may receive a notification when the load level of any one of the RADIUS servers has exceeded a first threshold or fallen below a second threshold. Therefore, the network device 200 may for example distribute requests to those servers whose load level has not exceeded the first threshold or has fallen below the second threshold. In some examples, if the load level of all of the RADIUS servers has exceeded the first threshold or has not fallen below the second threshold, the network device may not distribute the request or may select any one of the RADIUS servers in any suitable manner (e.g. preferred server or round-robin).

In some examples, the load level of the first RADIUS server is based on one or more of a CPU utilization of the first RADIUS server, a number of services (including services related to RADIUS operations and/or other services) running on the first RADIUS server, and a number of security threats to the first RADIUS server. Where the load level is based on a number of security threats, the presence of one or more security threats to the first RADIUS server may prompt a notification that the load level first RADIUS server has exceeded the first threshold to ensure that subsequent threats are not sent to the first RADIUS server. In effect, in some examples, a security threat may be treated as a load on the RADIUS server for the purposes of distributing requests.

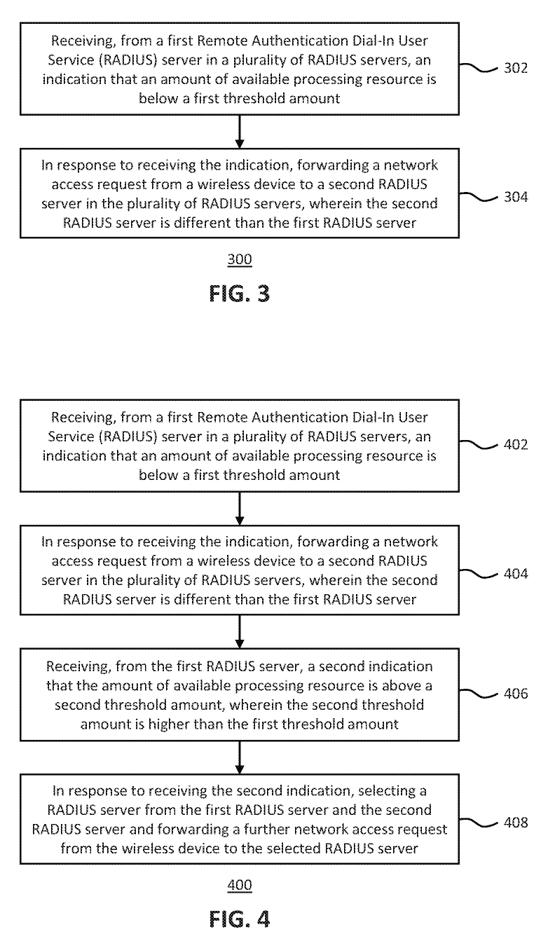

FIG. 3 is a flow chart of an example of a method 300, for example a method of distributing a network access request between RADIUS servers. The method 300 comprises, in block 302, receiving, from a first Remote Authentication Dial-In User Service (RADIUS) server in a plurality of RADIUS servers, an indication that an amount of available processing resource is below a first threshold amount. The available processing resource may be based on for example one or more of CPU utilization, a number of services (including services related to RADIUS operations and/or other services) running on the first RADIUS server, and a number of security threats to the first RADIUS server.

The method 300 also comprises, in block 304, in response to receiving the indication, forwarding a network access request from a wireless device to a second RADIUS server in the plurality of RADIUS servers, wherein the second RADIUS server is different than the first RADIUS server. Thus, for example, the network access request is not forwarded to the first RADIUS server where it has indicated that the amount of available processing resource is below the first threshold amount. In some examples, the selection of the second RADIUS server is done using any suitable method, e.g. round-robin or selection of a preferred server, though the second server is selected from the plurality of RADIUS servers excluding the first RADIUS server.

FIG. 4 is a flow chart of an example of a method 400, for example a method of distributing a network access request between RADIUS servers. The method 400 comprises, in block 402, receiving, from a first Remote Authentication Dial-In User Service (RADIUS) server in a plurality of RADIUS servers, an indication that an amount of available processing resource is below a first threshold amount. The method 400 also comprises, in block 404, in response to receiving the indication, forwarding a network access request from a wireless device to a second RADIUS server in the plurality of RADIUS servers, wherein the second RADIUS server is different than the first RADIUS server. In some examples, the blocks 402 and 404 are similar or identical to the blocks 302 and 304 of the method 300.

The method 400 also comprises, in block 406, receiving, from the first RADIUS server, a second indication that the amount of available processing resource is above a second threshold amount, wherein the second threshold amount is higher than the first threshold amount, and in block 408, in response to receiving the second indication, selecting a RADIUS server from the first RADIUS server and the second RADIUS server and forwarding a further network access request from the wireless device to the selected RADIUS server. Thus, for example, when the amount of available processing resource at the first RADIUS server has risen above the second threshold amount, the further network access request (and also in some examples subsequent network access requests) may be distributed between the RADIUS servers (including the first and second RADIUS servers) using any suitable method such as e.g. round-robin or selection of a preferred server.

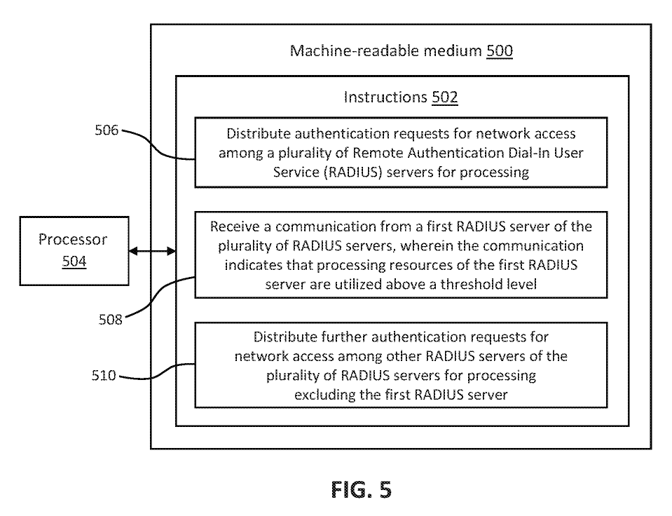

FIG. 5 is a simplified schematic of an example of a machine-readable medium 500 comprising instructions 502 that, when executed by a processor 504 of a network device, cause the processor 504 to distribute 506 authentication requests for network access among a plurality of Remote Authentication Dial-In User Service (RADIUS) servers for processing. The network device may in some examples be a RADIUS server such as a RADIUS Dynamic Authorization server (DAC). The plurality of RADIUS servers may in some examples comprise a plurality of RADIUS Dynamic Authorization Clients (DACs).

The instructions 502 include instructions that, when executed by the processor 504, cause the processor 504 to receive 508 a communication from a first RADIUS server of the plurality of RADIUS servers, wherein the communication indicates that processing resources of the first RADIUS server are utilized above a threshold level, and distribute 510 further authentication requests for network access among other RADIUS servers of the plurality of RADIUS servers for processing excluding the first RADIUS server. Therefore, in some examples, where the notification is received from the first RADIUS servers, further authentication requests are not provided to the first RADIUS server for processing.

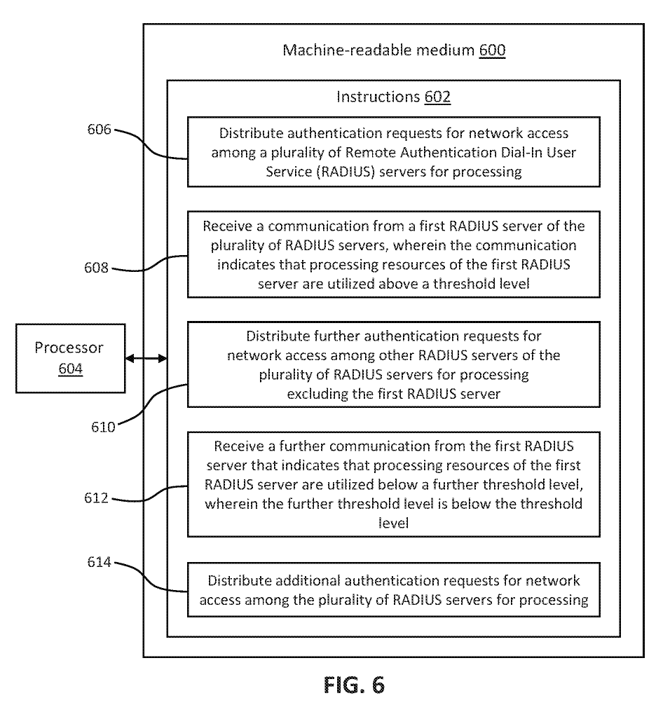

FIG. 6 is a simplified schematic of an example of a machine-readable medium 600 comprising instructions 602 that, when executed by a processor 604 of a network device, cause the processor 604 to distribute 606 authentication requests for network access among a plurality of Remote Authentication Dial-In User Service (RADIUS) servers for processing. The network device may in some examples be a RADIUS server such as a RADIUS Dynamic Authorization server (DAC). The plurality of RADIUS servers may in some examples comprise a plurality of RADIUS Dynamic Authorization Clients (DACs).

The instructions 602 include instructions that, when executed by the processor 604, cause the processor 604 to receive 608 a communication from a first RADIUS server of the plurality of RADIUS servers, wherein the communication indicates that processing resources of the first RADIUS server are utilized above a threshold level, and distribute 610 further authentication requests for network access among other RADIUS servers of the plurality of RADIUS servers for processing excluding the first RADIUS server.

The instructions 602 include instructions that, when executed by the processor 604, cause the processor to receive 612 a further communication from the first RADIUS server that indicates that processing resources of the first RADIUS server are utilized below a further threshold level, wherein the further threshold level is below the threshold level, and distribute 614 additional authentication requests for network access among the plurality of RADIUS servers for processing. For example, the additional authentication requests may be distributed among the RADIUS servers including the first RADIUS server when the fist RADIUS server has indicated that it has enough available processing resource to process authentication requests. In this manner, in some examples, the first RADIUS server may be excluded from or included in the RADIUS servers to which authentication requests are distributed, based on the utilization of the processing resources of the first RADIUS server. In some examples, each of one or more of the other RADIUS servers may also send communications when their processing resources are utilized above a threshold level, and when their processing resources are utilized below a further threshold level. Communications may in some examples be sent or received periodically or in response to the utilization of processing resources passing the threshold level or the further threshold level.

In some examples, the communication from the first RADIUS server indicates that the processing resources of the first RADIUS server are utilized above the threshold level based on one of a CPU utilization of the first RADIUS server, a number of services running on the first RADIUS server, and a number of security threats to the first RADIUS server. In some examples, the communication from the first RADIUS server comprises a Change of Authorization (CoA) request (CoA-request) that contains appropriate information (e.g. parameters) to indicate that processing resources of the first RADIUS server are utilized above a threshold level.

In some examples, the utilization of processing resources, a load level, or the amount of available processing resource of a RADIUS server is indicated by a load balancing index. This may be for example an indicator of an average of server processing load over a period of time, such as for example a recurring period of time where the load balancing index is determined periodically. The server processing load may be based on or indicated by one or more parameters including one or more of processor utilization in a server, the number of services running concurrently in the server, a number of security threats to the server, and/or one or more other suitable parameters. Each parameter may in some examples be given a weight. Thus, for example, the load balancing index may be calculated using the formula L=Σ WᵢPᵢ, i=1, . . . n, where L is the load balancing index for the server, n is the number of parameters used to calculate the load balancing index, Pᵢ is the parameter and Wᵢ is the weight given to parameter i.

Examples in the present disclosure can be provided as methods, systems or machine readable instructions, such as any combination of software, hardware, firmware or the like. Such machine readable instructions may be included on a computer readable storage medium (including but is not limited to disc storage, CD-ROM, optical storage, etc.) having computer readable program codes therein or thereon.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. It shall be understood that each flow and/or block in the flow charts and/or block diagrams, as well as combinations of the flows and/or diagrams in the flow charts and/or block diagrams can be realized by machine readable instructions.

The machine readable instructions may, for example, be executed by a general purpose computer, a special purpose computer, an embedded processor or processors of other programmable data processing devices to realize the functions described in the description and diagrams. In particular, a processor or processing apparatus may execute the machine readable instructions. Thus functional modules of the apparatus and devices may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine readable instructions may also be stored in a computer readable storage that can guide the computer or other programmable data processing devices to operate in a specific mode.

Such machine readable instructions may also be loaded onto a computer or other programmable data processing devices, so that the computer or other programmable data processing devices perform a series of operations to produce computer-implemented processing, thus the instructions executed on the computer or other programmable devices realize functions specified by flow(s) in the flow charts and/or block(s) in the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the spirit of the present disclosure. It is intended, therefore, that the method, apparatus and related aspects be limited only by the scope of the following claims and their equivalents. It should be noted that the above-mentioned examples illustrate rather than limit what is described herein, and that those skilled in the art will be able to design many alternative implementations without departing from the scope of the appended claims.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A network device comprising:
a memory;
a processor to execute instructions stored in the memory to:
receive a notification that a load level of a first Remote Authentication Dial-In User Service (RADIUS) server of a plurality of RADIUS servers for network access authentication of a network has exceeded a first threshold load level;
receive a request from a client device to access a network resource in the network; and
forward the request to a second RADIUS server from the plurality of RADIUS servers, wherein the second RADIUS server is different from the first RADIUS server.

2. The network device of claim 1, wherein the processor is to execute instructions stored in the memory to receive a further notification that the load level of the first RADIUS server is below a second threshold load level, wherein the second threshold level is lower than the first threshold level.

3. The network device of claim 1, wherein the network devices comprises a RADIUS Dynamic Authorization Server (DAS) and the plurality of RADIUS servers comprise a plurality of RADIUS Dynamic Authorization Clients (DACs).

4. The network device of claim 1, wherein the processor is to execute instructions stored in the memory to receive the notification by receiving a Change of Authorization (CoA) Request from the first RADIUS server, wherein a parameter of the CoA Request indicates that the load level has exceeded the first threshold level.

5. The network device of claim 1, wherein the processor is to execute instructions stored in the memory to select the second RADIUS server from the plurality of RADIUS servers as a preferred server or using round-robin selection.

6. The network device of claim 1, wherein the load level of the first RADIUS server is based on one of a CPU utilization of the first RADIUS server, a number of services running on the first RADIUS server, and a number of security threats to the first RADIUS server.

7. A method comprising:
receiving, from a first Remote Authentication Dial-In User Service (RADIUS) server in a plurality of RADIUS servers, an indication that an amount of available processing resource is below a first threshold amount; and
in response to receiving the indication, forwarding a network access request from a wireless device to a second RADIUS server in the plurality of RADIUS servers, wherein the second RADIUS server is different than the first RADIUS server.

8. The method of claim 7, further comprising:
receiving, from the first RADIUS server, a second indication that the amount of available processing resource is above a second threshold amount, wherein the second threshold amount is higher than the first threshold amount; and
in response to receiving the second indication, selecting a RADIUS server from the first RADIUS server and the second RADIUS server and forwarding a further network access request from the wireless device to the selected RADIUS server.

9. The method of claim 8, wherein the selected RADIUS server is selected from the first RADIUS server or the second RADIUS server using round-robin selection or by selecting a preferred one of the first RADIUS server and the second RADIUS server.

10. The method of claim 7, wherein forwarding the network access request from the wireless device to the second RADIUS server comprises selecting the second RADIUS server from the plurality of RADIUS servers using round-robin selection or by selecting a preferred one of the plurality of RADIUS servers.

11. A machine-readable medium comprising instructions that, when executed by a processor of a network device, cause the processor to:
distribute authentication requests for network access among a plurality of Remote Authentication Dial-In User Service (RADIUS) servers for processing;
receive a communication from a first RADIUS server of the plurality of RADIUS servers, wherein the communication indicates that processing resources of the first RADIUS server are utilized above a threshold level; and
distribute further authentication requests for network access among other RADIUS servers of the plurality of RADIUS servers for processing excluding the first RADIUS server.

12. The machine-readable medium of claim 12, comprising instructions that, when executed by a processor of a network device, cause the processor to:
receive a further communication from the first RADIUS server that indicates that processing resources of the first RADIUS server are utilized below a further threshold level, wherein the further threshold level is below the threshold level; and
distribute additional authentication requests for network access among the plurality of RADIUS servers for processing.

13. The machine-readable medium of claim 11, wherein the network device comprises a RADIUS Dynamic Authorization Server (DAS) and each of the plurality of RADIUS servers comprises a RADIUS Dynamic Authorization Client (DAC).

14. The machine-readable medium of claim 11, wherein the communication indicates that the processing resources of the first RADIUS server are utilized above the threshold level based on one of a CPU utilization of the first RADIUS server, a number of services running on the first RADIUS server, and a number of security threats to the first RADIUS server.

15. The machine-readable medium of claim 11, wherein the communication from the first RADIUS server comprises a Change of Authorization (CoA) request (CoA-request).
